(19) United States
(12) Patent Application Publication
(10) Pub. No.: US 2008/0122130 A1
(43) Pub. Date: May 29, 2008

(54) Method for making polysiloxane lenses

(75) Inventor: Ching-Shu Shih, Taichung County (TW)

Correspondence Address: BROWDY AND NEIMARK, P.L.L.C.;624 NINTH STREET, NW, SUITE 300, WASHINGTON, DC, 20001-5303, US

(73) Assignee: Genius Electronic Optical Co., Ltd., Taichung (TW)

(21) Appl. No.: 11/704,316

(22) Filed: Feb. 9, 2007

(30) Foreign Application Priority Data
Nov. 23, 2006 (TW) 95143418

(51) Int. Cl. B29D 11/00

(52) U.S. Cl. 264/2.6

(57) ABSTRACT

A method for making polysiloxane lenses includes the steps of preparing a first mold block having a land area and a second mold block having a land area in which a plurality of independent cavities are formed, keeping the first mold block away from the second mold block, injecting fluid polysiloxane into every cavity of the second mold block, closing the land area of the first mold block on the land area of the second mold block, heating the first mold block and the second mold block to have the fluid polysiloxane in the cavities of the second mold block be hardened into individual polysiloxane lenses, and separating the first mold block from the second mold block and removing the hardened polysiloxane lenses out of the cavities of the second mold block.

### BACKGROUND OF THE INVENTION

1. Field of the Invention

The present invention relates generally to polysiloxane lenses and more specifically, to a method for making polysiloxane lenses.

2. Description of the Related Art

A regular polysiloxane lens fabrication method is known comprising the steps of (a) closing a prepared mold, (b) filling fluid polysiloxane into a filling hole on the mold for enabling the applied fluid polysiloxane to be guided by flow passages to multiple cavities in the mold, (c) heating the mold to harden polysiloxane in every cavity, (d) opening the mold and taking the hardened and connected polysiloxane lenses out of the cavities of the mold, and (e) cutting off the connection between each two polysiloxane lenses so as to obtain individual polysiloxane lenses.

However, the aforesaid polysiloxane lens fabrication method wastes a lot of polysiloxane. Because polysiloxane is an expansive material, wasting the material relatively increases the manufacturing cost of polysiloxane lenses. Further, the procedure of cutting off connection between each two polysiloxane lenses complicates the fabrication and also relatively increases the fabrication time.

### SUMMARY OF THE INVENTION

The present invention has been accomplished under the circumstances in view. It is one objective of the present invention to provide a polysiloxane lens fabrication method, which reduces material waste.

It is another objective of the present invention to provide a polysiloxane lens fabrication method, which saves much fabrication time and labor.

To achieve these objectives of the present invention, the polysiloxane lens fabrication method comprises the steps of (a) preparing a first mold block having a land area and a second mold block having a land area in which a plurality of independent cavities are formed; (b) keeping the first mold block away from the second mold block; (c) injecting fluid polysiloxane into every cavity of the second mold block; (d) closing the land area of the first mold block on the land area of the second mold block; (e) heating the first mold block and the second mold block to have the fluid polysiloxane in the cavities of the second mold block be hardened to form individual polysiloxane lenses; and (f) separating the first mold block from the second mold block and removing the polysiloxane lenses out of the cavities of the second mold block.

In a preferred embodiment, the fluid polysiloxane is injected into the cavities of the second mold block by a plurality of injectors synchronously. Alternatively, the fluid polysiloxane can be injected into the cavities of the second mold block one after another by a single injector. In addition, the polysiloxane lenses are removed out of the cavities of the second mold block by means of a vacuum suction force. Alternatively, the polysiloxane lenses can be removed out of the cavities by using a plurality of pins to eject the polysiloxane lenses out of the cavities.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a flow chart of the polysiloxane lens fabrication method according to the present invention;

FIG. 2 is a schematic drawing of a mold for the polysiloxane lens fabrication method according to the present invention;

FIG. 3 is a schematic drawing, showing fluid polysiloxane injected into the cavities of the second mold block according to the present invention;

FIG. 4 is a schematic drawing, showing the first mold block closed on the second mold block after injection of fluid polysiloxane into the cavities of the second mold block according to the present invention, and

FIG. 5 is a schematic drawing, showing hardened polysiloxane lenses removed out of the respective cavities.

### DETAILED DESCRIPTION OF THE INVENTION

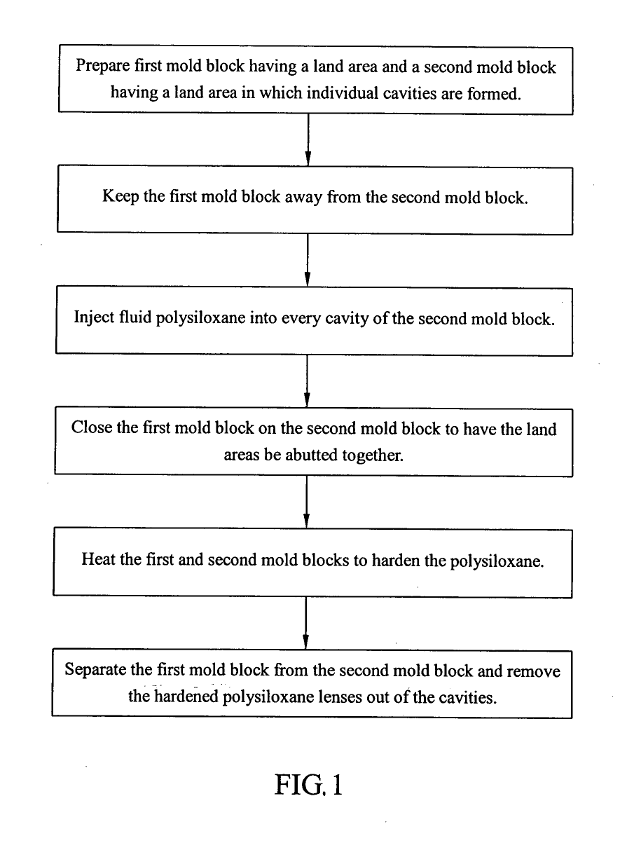

Referring to FIGS. 1-5, a polysiloxane lens fabrication method includes the following steps.

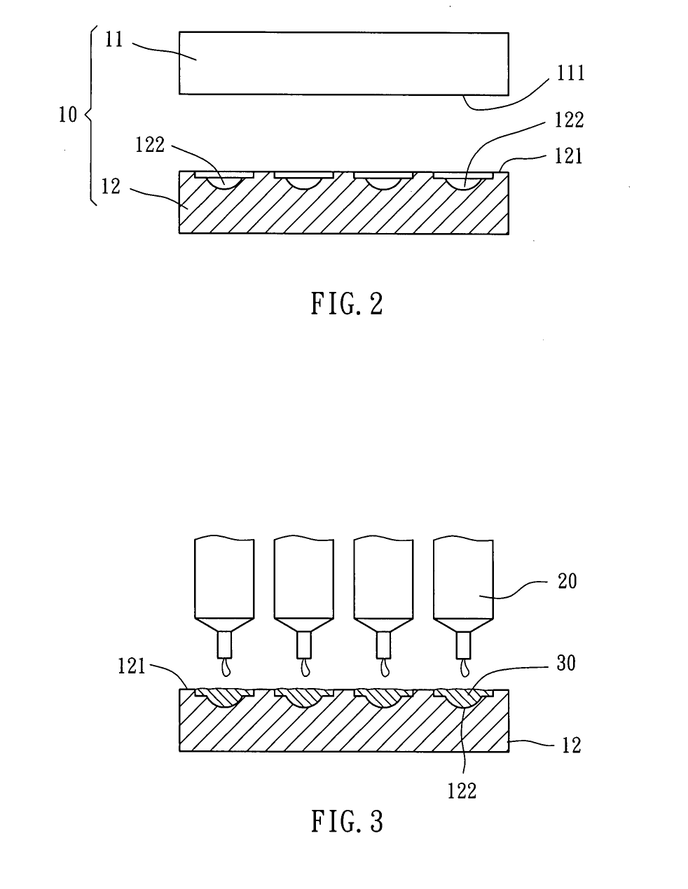

(a) Prepare a mold 10 comprised of a first mold block 11 and a second mold block 12. The first mold block 11 has a land area 111. The second mold block 12 has a land area 121 facing the land area 111 of the first mold block 11 and a plurality of independent cavities 122 in the land area 121. Each cavity 122 has a configuration subject to the contour of the polysiloxane lenses to be made (see FIG. 2).

(b) keep the first mold block 11 away from the second mold block 12 to have the land area 111 of the first mold block 11 be apart from the land area 121 of the second mold block 12 at a predetermined distance as shown in FIG. 2.

(c) Use a number of injectors (syringes) 20 to inject fluid polysiloxane 30 into the cavities 122 of the second mold block 12 either one after another or simultaneously as shown in FIG. 3.

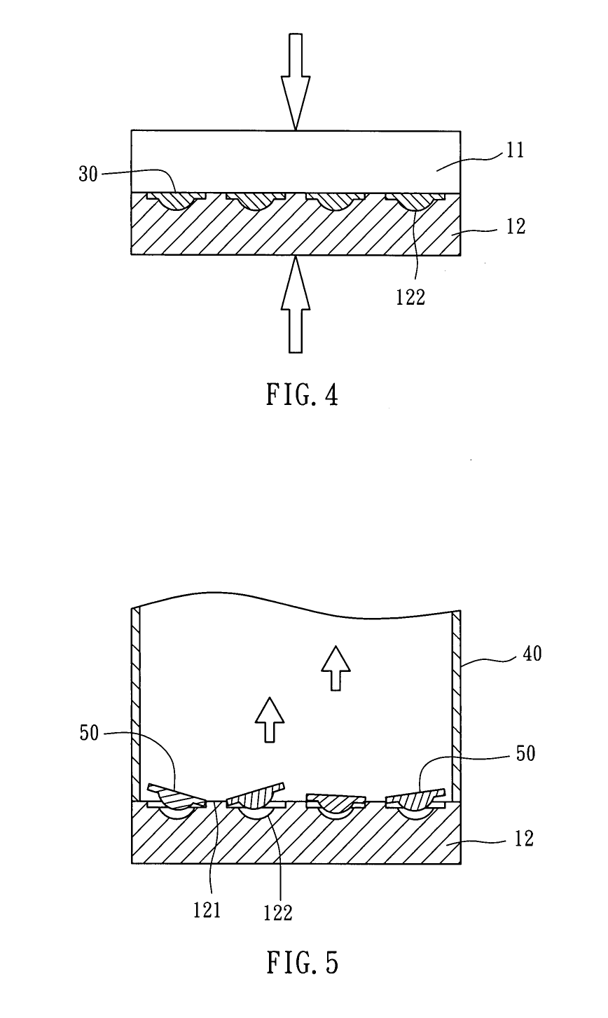

(d) Close the first mold block 11 and the second mold block 12 to have the land areas 111 and 121 be abutted against each other as shown in FIG. 4.

(e) Heat the closed mold 10 to a predetermined temperature for a predetermined period of time to have the fluid polysiloxane 30 in each cavity 122 be harden to form polysiloxane lenses having the predetermined configuration.

(f) Remove the first mold block 11 from the second mold block 12 to keep the land area 111 of the first mold block 11 away from the land area 121 of the second mold block 12 at a distance, and then attach a vacuum tube 40 to the land area 121 of the second mold block 12 and apply a vacuum to the vacuum tube 40 to suck the respective hardened polysiloxane lenses 50 away from the respective cavities 122 or to a predetermined external place as shown in FIG. 5.

During step (c), a single injector (syringe) may be used to inject fluid polysiloxane 30 into the cavities 122 of the second mold block 12 one after another in proper order, or multiple injectors (syringes) may be simultaneously used to synchronously inject fluid polysiloxane 30 into the cavities 122 of the second mold block 12.

Further, ejector pins may be used to eject the respective hardened polysiloxane lenses 50 out of the respective cavities 122 instead of using the vacuum-sucking method as mentioned in step (f) above.

As stated above, the polysiloxane lens fabrication method of the present invention uses injector(s) to inject fluid polysiloxane into each cavity of the second mold block directly before closing the mold. Thus, it is not necessary to make a filling hole on the mold for the filling of the fluid polysiloxane or flow passages for guiding the applied polysiloxane from the filling hole to each of the cavities. Therefore, the invention eliminates the drawback of accumulation of residual fluid polysiloxane in the filling hole and the flow passages as commonly seen in conventional techniques, and saves much the material. Further, when hardened polysiloxane lenses are ejected out of the respective cavities, they are kept apart and sorted individually. Therefore, the invention does not require a cutting procedure to separate the hardened polysiloxane lenses. Therefore, the fabrication method of the present invention saves much time and labor, and greatly improves the fabrication efficiency.

What is claimed is:

1. A method for making polysiloxane lenses comprising the steps of:
(a) preparing a first mold block having a land area and a second mold block having a land area in which a plurality of independent cavities are formed;
(b) keeping the first mold block away from the second mold block;
(c) injecting fluid polysiloxane into every cavity of the second mold block;
(d) closing the land area of the first mold block on the land area of the second mold block;
(e) heating the first mold block and the second mold block to have the fluid polysiloxane in the cavities of the second mold block be hardened to form individual polysiloxane lenses; and
(f) separating the first mold block from the second mold block and removing the individual polysiloxane lenses out of the cavities of the second mold block.

2. The method as claimed in claim 1, wherein the fluid polysiloxane is injected into the cavities of the second mold block one after another by an injector in step (c).

3. The method as claimed in claim 1, wherein the fluid polysiloxane is injected into the cavities of the second mold block by a plurality of injectors in step (c).

4. The method as claimed in claim 1, wherein the individual polysiloxane lenses are removed out of the cavities of the second mold block by means of a vacuum suction force in step (f).

5. The method as claimed in claim 1, wherein the individual polysiloxane lenses are removed out of the cavities of the second mold block by means of attaching a vacuum tube to the land area of the second mold block and then applying a vacuum to the vacuum tube to suck the individual polysiloxane lenses out of the cavities of the second mold block in step (f).

6. The method as claimed in claim 1, wherein the individual polysiloxane lenses are removed out of the cavities of the second mold block (f) by means of the application of multiple ejector pins to eject the individual polysiloxane lenses out of the cavities of the second mold block in step (f).
